(19) United States
(12) Patent Application Publication
(10) Pub. No.: US 2026/0228954 A1
(43) Pub. Date: Aug. 6, 2026

(54) SYSTEMS AND METHODS FOR DIFFUSION-BASED VIDEO GENERATION

(71) Applicant: Netflix, Inc., Los Gatos, CA (US)

(72) Inventors: Julien Olivier Victor Philip, London (FR); Li Ma, Los Angeles, CA (US); Pascal Clausen, Villeneuve (CH); Wenqi Xian, Los Angeles, CA (US); Ahmet Levent Tasel, Vancouver (CA); Mingming He, Los Angeles, CA (US); Xueming Yu, South Pasadena, CA (US); David M. George, Cerritos, CA (US); Ning Yu, Los Angeles, CA (US); Oliver Pilarski, Gechingen (DE); Paul E. Debevec, Culver City, CA (US); Rahul Garg, Sunnyvale, CA (US); Ryan Burgert, Los Angeles, CA (US); Yiwei Zhao, Los Angeles, CA (US); Yuancheng Xu, Los Angeles, CA (US)

(21) Appl. No.: 19/531,128

(22) Filed: Feb. 5, 2026

Related U.S. Application Data
(60) Provisional application No. 63/811,345, filed on May 23, 2025.
(60) Provisional application No. 63/754,824, filed on Feb. 6, 2025.

(51) Int. Cl. G06T 13/40; G06T 3/18; G06T 5/92; G06T 7/246; G06T 7/80; G06T 15/08; G06T 15/20; G06T 15/50; G06T 17/00

(52) U.S. Cl. CPC G06T 13/40; G06T 3/18; G06T 5/92; G06T 7/246; G06T 7/80; G06T 15/08; G06T 15/20; G06T 15/503; G06T 15/506; G06T 17/00; G06T 2207/10016; G06T 2207/10024; G06T 2207/20081; G06T 2207/20208; G06T 2207/30201; G06T 2207/30204; G06T 2207/30244

(57) ABSTRACT

Methods for diffusion-based video generation include capturing multi-actor performances in a scene rig and capturing single-actor facial detail in a face rig. Dynamic performances are reconstructed from the scene rig using four-dimensional Gaussian splatting. For each actor for which single-actor facial detail is captured, a low-quality model and a high-quality model are constructed based on the facial detail and paired image sequences are produced. A diffusion-based detail-enhancement model is trained using the paired image sequences, and high-quality images are rendered for facial closeups by applying the trained diffusion-based detail enhancement model to the reconstructed dynamic performances from the scene rig. Various other methods and systems are also disclosed.

### CROSS REFERENCE TO RELATED APPLICATION

This application claims the benefit of U.S. Provisional Application No. 63/811,345, filed 23 May 2025, and of U.S. Provisional Application No. 63/754,824 filed 06 February 2025, the entire contents of which are incorporated by this reference.

### BACKGROUND

Many media production houses and digital content creators now demand free-viewpoint video that supports both wide-angle ensemble shots and high resolution facial closeups. In such capture environments, large scale volumetric systems can record multi-actor performances over extensive areas. Because these reconstructions often lack the spatial detail required for production quality output, particularly at the video resolutions demanded for cinematic closeups, subject fidelity and precise camera control become increasingly challenging when generative diffusion-based models are applied to complex, dynamic scenes.

Conventional volumetric reconstruction techniques often rely on mesh-based multi-view stereo or neural radiance fields. However, these methods frequently fail to preserve fine facial features and maintain temporal coherence at scale. Moreover, post processing approaches such as super resolution and frame interpolation aim to sharpen these reconstructions, yet they often introduce artifacts, temporal instability, or misalignment with the underlying motion data. Likewise, off-the-shelf diffusion-based enhancement tools can impart additional detail but typically lack awareness of volumetric geometry, resulting in flicker and composition errors when integrated with dynamic free-viewpoint footage.

### SUMMARY

As will be described in greater detail below, the present disclosure describes systems and methods for diffusion-based video generation that address some or all of the deficiencies noted above.

In some aspects, the techniques described herein relate to methods, including: capturing multi-actor performances using a scene rig including a stage and multiple scene cameras; reconstructing dynamic performances from the scene rig using four-dimensional Gaussian splatting; capturing single-actor facial detail using a face rig including multiple face cameras; constructing, for each actor, a low-quality (LQ) Gaussian splatting model and a high-quality (HQ) Gaussian splatting model based on the captured single-actor facial detail using the face rig; rendering the LQ and HQ Gaussian splatting models to produce paired image sequences for each actor; training a diffusion-based detail enhancement model using the paired image sequences; and rendering HQ images for facial closeups by applying the trained diffusion-based detail enhancement model to the reconstructed dynamic performances from the scene rig.

In some embodiments of the disclosed methods, the LQ Gaussian splatting model includes between 50,000 and 200,000 Gaussians per frame and the HQ Gaussian splatting model includes 1 million or more Gaussians per frame. In some examples, reconstructing the dynamic performances includes correcting spatially variable exposure and black-level values to compensate for lens glare and sensor variability in the captured multi-actor performances. In some examples, the multiple scene cameras include stationary scene cameras positioned at various locations around the stage and dynamic scene cameras that perform pan, tilt, zoom, and focus adjustments based on the multi-actor performances. In some examples, capturing the multi-actor performances further includes tracking actor movement with the dynamic scene cameras using motion-capture markers affixed to the actors. In some examples, the methods further include: calibrating the multiple scene cameras in the scene rig, including: calibrating only the stationary scene cameras using lidar scans while keeping focal lengths of the stationary scene cameras fixed; after calibrating only the stationary scene cameras, fixing positions of the stationary cameras in the scene rig; and after calibrating only the stationary scene cameras, separately calibrating the dynamic scene cameras. In some examples, calibrating the dynamic scene cameras includes fitting a smooth function to changes in focal length provided by the dynamic scene cameras and using the smooth function as a regularization across frames to account for zoom changes and to reduce inconsistencies in calibration.

In further embodiments of the disclosed methods, capturing the multi-actor performances includes capturing a color chart and capturing the single-actor facial detail includes capturing the color chart. In some examples, the methods further include calibrating the color of the captured multi-actor performances and of the captured single-actor facial detail to each other using the captured color chart. In some examples, capturing the multi-actor performances includes capturing multiple actors performing a variety of actions on the stage. In some examples, capturing the single-actor facial detail includes capturing a single actor performing a variety of facial expressions. In some examples, rendering the LQ and HQ Gaussian splatting models to produce paired image sequences for each actor includes: rendering LQ red-green-blue (RGB) images and LQ alpha images from the LQ Gaussian splatting model; and rendering HQ RGB images and HQ alpha images from the HQ Gaussian splatting model; and training the diffusion-based detail enhancement model using the paired image sequences includes: comparing a current output frame of the HQ RGB images to a previous output frame of the HQ RGB images to generate a warped version of the previous output frame and a warp validity mask; and conditioning the diffusion-based detail enhancement model using the LQ RGB images, LQ alpha images, warped version of the previous output frame, and warp validity mask. In some examples, rendering the HQ images for facial closeups by applying the trained diffusion-based detail enhancement model includes outputting detail-enhanced red-green-blue (RGB) images and detail-enhanced alpha images for alpha compositing.

In some aspects, the techniques described herein relate to additional methods, including: capturing, using a face rig including a plurality of face cameras, detailed images of an actor’s face performing various facial expressions; capturing, using a scene rig including a plurality of scene cameras, full-body performances of the actor; reconstructing, via four-dimensional Gaussian splatting, a time-varying volumetric representation of the actor based on the captured detailed images from the face rig and the captured full-body performances from the scene rig; rendering, from the volumetric representation and along simulated camera trajectories, a plurality of two-dimensional video sequences of the actor to produce a multi-view training dataset paired with associated camera parameters; fine-tuning a pretrained video generation model on the multi-view training dataset and the associated camera parameters to create a customized video generation model associated with the actor while preserving identity consistency across varying viewpoints; and generating, by providing the customized video generation model with a token associated with the actor and a specified camera trajectory, an actor-specific video output that follows the specified camera trajectory and that maintains coherent multi-view identity of the actor.

In some embodiments of the additional methods, the methods further include applying a video relighting model to the rendered two-dimensional video sequences to generate relighted video sequences, wherein the multi-view training dataset further includes the relighted video sequences. In some examples, the multi-view training dataset is augmented by rendering the volumetric representation along a plurality of diverse camera trajectories generated by randomly sampling starting and ending positions within a specified radius and interpolating between the starting and ending positions to create smooth motion paths. In some examples, generating the actor-specific video output further includes providing a text prompt to the customized video generation model. In some examples, the plurality of face cameras include face cameras respectively positioned to capture the actor’s face from a front of the face and from sides of the face. In some examples, the additional methods further include pretraining a video generation model to obtain the pretrained video generation model, wherein the pretraining includes training the video generation model to recognize three-dimensional camera positions and parameters as input. In some examples, the video generation model includes a video diffusion model.

In some aspects, the techniques described herein relate to systems, including: at least one physical processor; and physical memory including computer-executable instructions that, when executed by the physical processor, cause the physical processor to: reconstruct, from captured multi-actor performances in a scene rig including a stage and multiple scene cameras, dynamic performances using four-dimensional Gaussian splatting; construct, for each actor and from captured single-actor facial detail in a face rig including multiple face cameras, a low-quality (LQ) Gaussian splatting model and a high-quality (HQ) Gaussian splatting model; render the LQ and HQ Gaussian splatting models to produce paired image sequences for each actor; train a diffusion-based detail enhancement model using the paired image sequences; and render HQ images for facial closeups by applying the trained diffusion-based detail enhancement model to the reconstructed dynamic performances from the scene rig.

Features from any of the embodiments described herein can be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a flow diagram of an example method for diffusion-based video generation, according to at least one embodiment of the present disclosure.

FIG. 2 is a block diagram of an example system for performing the method of FIG. 1, according to at least one embodiment of the present disclosure.

FIG. 3 is a diagram illustrating a scene rig for capturing a multi-actor performance, according to at least one embodiment of the present disclosure.

FIG. 4 is a diagram illustrating a face rig for capturing single-actor facial detail, according to at least one embodiment of the present disclosure.

FIG. 5 is a flow diagram illustrating a pipeline for generating detail-enhanced videos, according to at least one embodiment of the present disclosure.

FIG. 6 is a block diagram showing a process for generating detail-enhanced videos, according to at least one embodiment of the present disclosure.

FIG. 7 is a block diagram showing an example implementation of a process for generating detail-enhanced videos, according to at least one embodiment of the present disclosure.

FIG. 8 is a block diagram showing a process for generating videos along a specified trajectory, according to at least one embodiment of the present disclosure.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within the scope of the appended claims.

### DETAILED DESCRIPTION OF EXAMPLE EMBODIMENTS

The present disclosure is generally directed to diffusion-based video generation systems that can accurately and efficiently reconstruct scenes, including both long shots and close-up shots. As noted above, existing systems face notable challenges when attempting to balance scalability, subject fidelity, and temporal stability in dynamic, multi-actor environments. Conventional volumetric reconstruction techniques, such as mesh-based multi-view stereo or neural radiance fields (NeRFs), often fail to preserve fine facial features and struggle with maintaining temporal coherence across extended sequences. These methods are further constrained by their inability to handle dynamic camera movements or produce production-grade facial closeups. Post-processing techniques, including super-resolution and frame interpolation, can introduce artifacts and temporal instability, while off-the-shelf diffusion-based enhancement tools lack awareness of volumetric geometry, leading to flicker and composition errors in free-viewpoint footage.

The present disclosure addresses these challenges by introducing a novel pipeline for diffusion-based video generation that integrates large-scale volumetric capture, dynamic reconstruction, and detail enhancement. The described approach leverages two complementary physical capture rigs: a scene rig for multi-actor, large-area performance capture and a face rig for high-fidelity facial detail acquisition. The scene rig incorporates both static and dynamic cameras, enabling the capture of multi-view performances with improved spatial detail and dynamic range. The face rig provides high-resolution facial data, which is used to train a diffusion-based detail enhancement model. This model is fine-tuned using paired data generated from low-quality and high-quality Gaussian Splatting (GS) reconstructions, ensuring that the enhancement process aligns with the volumetric geometry and maintains temporal stability.

The solution employs specialized algorithms and system architecture modifications to overcome the limitations of prior approaches. A 4D Gaussian Splatting (4DGS) (four dimensions refer to temporal coherence in addition to spatial coherence) method is used for dynamic scene reconstruction, featuring stable calibration of moving virtual cameras and improved color fidelity through exposure and black-level controls. Additionally, the detail enhancement model incorporates architectural changes to jointly predict RGB and alpha channels, ensuring seamless compositing and enhanced photorealism. Temporal stability is achieved through optical flow warping and low-frequency stabilization techniques, which mitigate flicker and ensure consistent rendering of fine details across frames. The disclosed pipeline supports 4K resolution outputs, enabling production-quality rendering for facial closeups and dynamic scenes, while maintaining scalability for large-scale multi-actor environments.

By combining advanced volumetric capture systems, innovative reconstruction techniques, and diffusion-based enhancement models, the described technology bridges the gap between scalable performance capture and the high-resolution standards for professional media production. This unified approach not only enhances subject fidelity and temporal coherence but also provides precise camera control and lighting adaptability, making the technology applicable to a wide range of uses, including, for example, cinematic productions, virtual reality, and customized video generation.

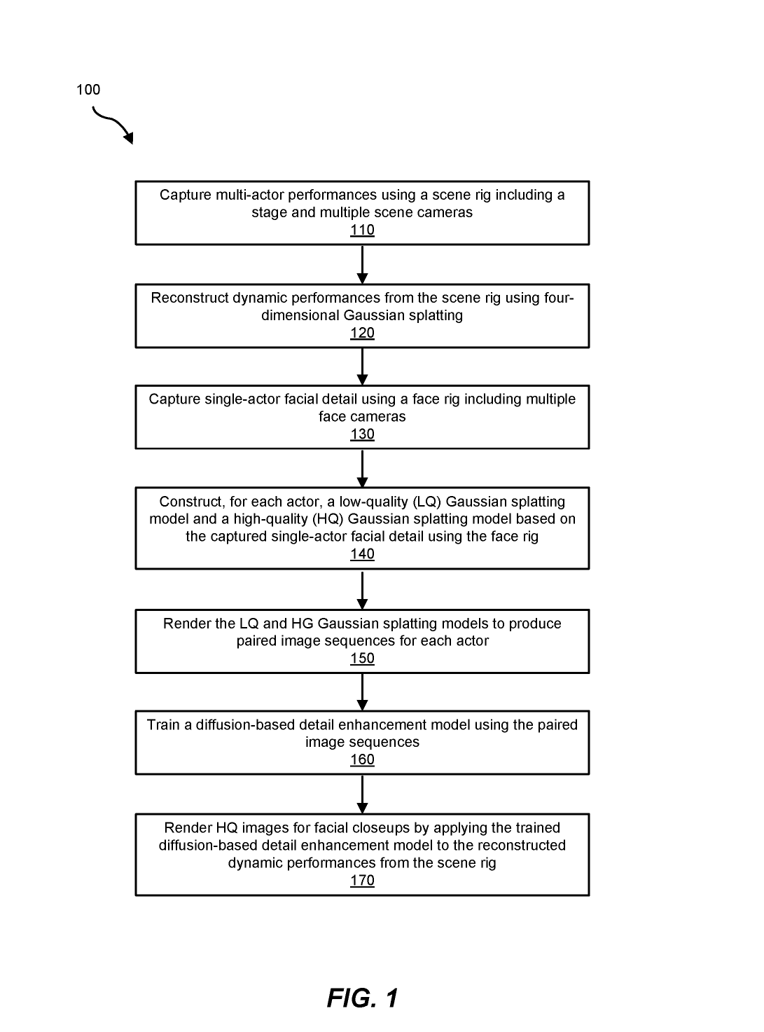

The following will provide, with reference to FIGS. 1-8, detailed descriptions of systems and methods for diffusion-based video generation, according to various embodiments of the present disclosure.

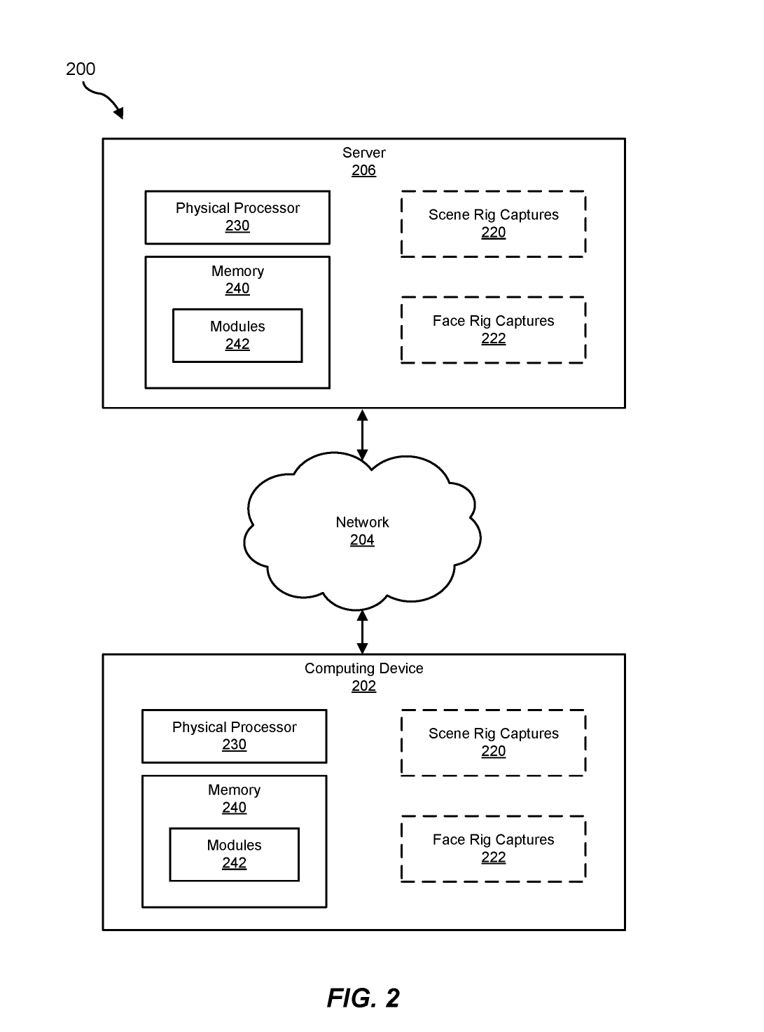

FIG. 1 is a flow diagram of an example method 100 for diffusion-based video generation, according to at least one embodiment of the present disclosure. The steps shown in FIG. 1 can be performed by any suitable computer-executable code and/or computing system, including system 200 illustrated in FIG. 2. In one example, each of the steps shown in FIG. 1 represents an algorithm whose structure includes and/or is represented by multiple sub-steps, examples of which will be provided in greater detail below.

At step 110, multi-actor performances are captured using a scene rig including a stage and multiple scene cameras. Step 110 can be performed in a variety of ways. For example, the scene rig includes a large performance area with calibrated static cameras positioned around the stage to provide wide field-of-view coverage and dynamic cameras configured with pan, tilt, zoom, and focus control to track actors’ faces and bodies during motion. In one embodiment, the scene rig includes many synchronized cameras, such as 90 static wide field of view (FOV) cameras, 40 landscape-view tracking cameras with zoom capability, and 50 additional portrait orientation cameras. In some examples, the static cameras are first calibrated using lidar scans and a reference frame while maintaining fixed focal lengths, and the dynamic cameras are subsequently calibrated with focal-length regularization across frames to account for zoom changes and to reduce intrinsic/extrinsic ambiguities. Tracking data can be obtained from unobtrusive motion-capture markers affixed to the actors’ wardrobe to improve aiming of the dynamic cameras. Illumination can be provided by synchronized LED lighting operating in short-duration strobes that are timed to camera shutters to reduce motion blur while maintaining actor comfort.

In some embodiments, color calibration is facilitated by capturing a standardized color chart in the scene rig to enable color matching across devices, rigs, and sessions. The scene rig records at high resolution and frame rates suitable for downstream reconstruction, such as 4K resolution at 24 frames per second, and includes ceiling-, wall-, and floor-mounted cameras to reduce occlusions as actors move throughout the stage. In some examples, exposure and black-level variations are intentionally logged per camera to support later compensation for veiling glare and sensor variability during reconstruction. The capture includes multiple takes in which actors perform diverse actions (e.g., walking, running, talking, gesturing, and/or interacting with props and/or other actors), with virtual camera trajectories and framing preferences planned in advance to ensure adequate coverage for subsequent four-dimensional Gaussian splatting and detail enhancement. As used herein, four-dimensional Gaussian splatting refers to a rendering technique that represents dynamic 2D or 3D scenes using Gaussian primitives, with an additional temporal dimension to capture changes over time. Each Gaussian primitive can be parameterized by properties such as mean, rotation, scale, and opacity, which are expressed as functions of time to ensure temporal coherence. This method enables smooth interpolation and accurate representation of dynamic scenes, making it suitable for applications requiring high-quality, time-varying volumetric reconstructions.

At step 120, dynamic performances from the scene rig are reconstructed using four-dimensional Gaussian splatting. Step 120 can be performed in a variety of ways. For example, a sequence of temporally indexed multi-view frames can be processed to initialize a dense per-frame point cloud that is used to seed a set of time-varying Gaussian primitives. Gaussian primitives are mathematical representations used in computer graphics and volumetric rendering to model spatial data as Gaussian functions. These primitives define properties such as mean, rotation, scale, and opacity, enabling smooth interpolation and accurate representation of dynamic or static scenes.

In some examples, a 4D Gaussian parameterization is employed in which each primitive’s mean, rotation, and opacity are expressed as low-order polynomials of time to capture smooth motion while sharing primitives across adjacent frames to increase effective per-frame detail. The Gaussian colors can be stored in an unbounded tone-mapped color space and linearized at rasterization to maintain high dynamic range and physically correct alpha compositing. Alpha compositing is a technique used in computer graphics to combine images or renderings by utilizing an alpha channel, which represents the transparency level of each pixel. This process involves blending the colors of overlapping images based on their alpha values, allowing for the creation of smooth transitions, semi-transparent effects, and realistic layering of visual elements. Alpha compositing can be used to blend an actor’s performance with a background (e.g., a separately captured background, a virtual background, etc.) in a natural and sometimes imperceptible way.

In some embodiments, antialiasing in the splatting rasterizer can be enabled to reduce high-frequency artifacts at extreme zoom levels, and pruning and relocation strategies can be utilized to maintain compact representations while preserving details. To balance quality and compute, long sequences can be segmented into shorter intervals that are trained independently and, in some cases, in parallel, with segment boundaries chosen to maintain temporal continuity of shared primitives. The resulting 4D Gaussian model can be rendered along virtual camera trajectories to produce temporally stable, color-faithful views that serve as input to downstream detail enhancement and compositing stages.

At step 130, single-actor facial detail is captured using a face rig including multiple face cameras. Step 130 can be performed in a variety of ways. For example, the face rig can include a cylindrical or dome-like enclosure lined with synchronized 4K cameras peering through narrow apertures to minimize parallax and reflections, with additional cameras mounted in the ceiling to capture top-down views of hairlines and crown regions. In one embodiment, approximately 75 cameras are evenly distributed around the rig to acquire dense multi-view coverage of the head and upper shoulders, with fixed focal lengths and calibrated baselines to ensure accurate multi-view geometry. Illumination can be provided by evenly distributed white LED fixtures configured for flat, diffuse lighting and short-duration strobes timed to camera shutters to reduce motion blur while preserving skin microdetail. A standardized color chart can be recorded at the start of each session to facilitate cross-rig color calibration with the scene rig.

In some implementations, actors are directed to perform a sequence of diverse facial expressions and micro-expressions, including neutral, smile, frown, brow raise, eye squint, mouth open/close, and head rotations at small and moderate angles. In some examples, the capture is organized into short subsequences (e.g., 8-12 frames) that are uniformly sampled across the session to provide broad coverage of expression space while maintaining temporal locality for downstream reconstruction. To enhance geometric fidelity, the face rig can incorporate head position markers affixed to a thin headband or behind-the-ear locations to aid pose estimation without occluding facial features. Depth-proxy cues such as structured light or photometric cues can optionally be recorded to improve surface normal estimation for areas with fine detail, including eyelashes, eyebrows, and hair wisps.

At step 140, for each actor, a low-quality (LQ) Gaussian splatting model and a high-quality (HQ) Gaussian splatting model are constructed based on the captured single-actor facial detail using the face rig. Step 140 can be performed in a variety of ways. For example, multi-view facial sequences are partitioned into short subsequences and reconstructed twice per subsequence using a four-dimensional Gaussian splatting pipeline. For example, the LQ Gaussian splatting model is a degraded version of a corresponding HQ Gaussian splatting model. The LQ Gaussian splatting model can be a constrained reconstruction that limits the number of Gaussians per frame to emulate scene-rig quality. The HQ Gaussian splatting model can be an unconstrained reconstruction that maximizes fidelity. In one embodiment, the LQ reconstruction targets a Gaussian budget sampled within a range, such as 50,000 to 200,000 Gaussians per frame, with antialiasing enabled and aggressive pruning/relocation to enforce compactness, while the HQ reconstruction targets one million or more Gaussians per frame with relaxed pruning thresholds to preserve microdetails including eyelashes, eyebrow fibers, and fine hair wisps. Both reconstructions can use time-polynomial parameterizations for mean, rotation, and opacity, with shared primitives across adjacent frames for temporal coherence. In some examples, to ensure consistent geometry, dense per-frame point clouds can be used to initialize both LQ and HQ Gaussian splatting models, followed by segment-wise training with identical camera intrinsics/extrinsics and lighting metadata, thereby isolating the effect of Gaussian budget as the primary variable controlling output quality.

Camera intrinsics/extrinsics refer to parameters that define the internal and external characteristics of a camera in relation to image formation and spatial positioning. Intrinsics include properties such as focal length, principal point, and lens distortion, which describe how the camera transforms 3D points in the scene into 2D image coordinates. Extrinsics define the camera’s position and orientation in space, specifying the transformation between the camera’s coordinate system and the world coordinate system. Together, these parameters are used for accurate 3D reconstruction and camera calibration.

In some embodiments, quality targets can be validated via held-out view comparisons and perceptual metrics to confirm that the LQ reconstruction approximates the degradation profile of scene-rig close-up renders, while the HQ reconstruction serves as ground truth for subsequent detail enhancement training. To facilitate paired dataset generation, the LQ and HQ models can be bound to a common set of virtual camera paths and frame indices, ensuring pixel-level correspondence of RGB and alpha renders across quality levels. The resulting per-actor LQ/HQ model pairs provide a controllable, identity-consistent basis for generating supervised training data that teaches a diffusion-based enhancement model to map scene-rig-like inputs to production-quality close-ups.

At step 150, the LQ and HQ Gaussian splatting models are rendered to produce paired image sequences for each actor. Step 150 can be performed in a variety of ways. For example, each model can be bound to identical virtual camera trajectories and frame indices so that corresponding LQ and HQ outputs are temporally and spatially aligned at the pixel level. For each paired subsequence, multiple virtual camera paths are synthesized to sweep focal lengths, depth-of-field, and viewpoint, yielding diverse paired sequences that cover a range of expressions, angles, zoom values, etc.

In some implementations, optical flow fields are computed between consecutive frames of the HQ sequence and used to warp the previous HQ frame to the current viewpoint, with a warp validity mask generated by comparing the warped LQ render to the current LQ frame. These auxiliary signals can be saved alongside RGB frames to serve as temporal conditioning inputs for training. In certain examples, per-sequence metadata including camera intrinsics/extrinsics, exposure and black-level grids, and segmentation masks identifying facial regions of interest are emitted with each paired render to facilitate downstream preprocessing and model supervision. The resulting dataset includes matched LQ RGB and alpha frames and HQ RGB and alpha frames for every time index and camera pose, providing structured supervision for diffusion-based detail enhancement.

At step 160, a diffusion-based detail enhancement model is trained using the paired image sequences. Step 160 can be performed in a variety of ways. For example, a pretrained image diffusion backbone can be adapted to accept multiple conditioning inputs by concatenating latent encodings of the LQ RGB, LQ alpha, a warped version of the previous HQ frame, and a corresponding warp validity mask to sampled latent noise prior to denoising.

Diffusion-based video generation can be performed by a video diffusion model, which is a type of machine learning framework designed to generate and/or enhance video content by iteratively refining noisy data into coherent video frames. These models typically employ a diffusion process, where random noise is progressively denoised using learned patterns, enabling the creation of high-quality videos from initial noise or low-quality inputs. Video diffusion models are often used for applications such as video synthesis, super-resolution, and customization.

In some embodiments, the latent space is expanded to jointly predict RGB and alpha by doubling the number of output channels, and the decoder separately reconstructs the RGB and alpha outputs to ensure aligned contours and fine silhouette detail. Training targets are the HQ RGB and HQ alpha frames, with reconstruction losses computed in linear color space for RGB and in a dedicated alpha loss for transparency fidelity. To encourage temporal stability, the network is trained with the warped previous HQ frame and with scheduled dropout on the temporal conditions for first frames to avoid over-reliance on unavailable inputs.

In some examples, training proceeds actor-wise and/or across actor subgroups to balance identity specialization and generalization, using distinct text prompts or identity tokens per actor or subgroup to retain strong natural image priors while learning actor-specific detail statistics. To improve robustness to flow inaccuracies, the warp validity mask is incorporated as a gating signal within attention blocks so that invalid regions default to conditioning on the current LQ inputs. The trained model produces temporally stable, high-fidelity RGB and alpha outputs suitable for downstream compositing.

At step 170, HQ images are rendered for facial closeups by applying the trained diffusion-based detail enhancement model to the reconstructed dynamic performances from the scene rig. Step 170 can be performed in a variety of ways. For example, the reconstructed four-dimensional Gaussian splatting output from the scene rig can be rasterized along artist-defined virtual camera paths to produce temporally stable LQ RGB frames, which are then fed into the enhancement model together with a warped version of the previous enhanced frame and its warp validity mask. The model jointly predicts detail-enhanced RGB and alpha channels, ensuring that fine silhouette elements such as eyelashes and hair wisps align between color and transparency. To suppress low-frequency flicker while preserving high-frequency detail, the lowest level of a Laplacian pyramid of the model’s output can be replaced with that of the LQ input prior to final tone mapping and delivery.

In some embodiments, closeup rendering proceeds at 4K resolution with antialiasing enabled and deterministic seeding to preserve shot-to-shot consistency across takes and edits. The enhancement can be applied only within dynamically determined face regions based on segmentation masks, with feathered borders to avoid seams when compositing with unenhanced body regions. The resulting HQ RGB frames can be exported in a high dynamic range, linear format for downstream color grading and relighting, and/or converted to display-referred color spaces for editorial review. When multiple actors are present, per-actor enhancement can be run independently with actor-specific checkpoints and merged during compositing, maintaining identity-consistent detail for each subject while adhering to the same virtual camera motion and stage lighting metadata.

FIG. 2 is a block diagram of an example system 200 for performing the method 100 of FIG. 1, according to at least one embodiment of the present disclosure. As illustrated in FIG. 2, a computing device 202 is in communication with a network 204, which is in communication with a server 206. Methods of the present disclosure can be performed by computing device 202, by server 206, or by a combination of computing device 202 and server 206 (e.g., some steps can be performed by computing device 202 and other steps can be performed by server 206).

System 200 includes one or more physical processors 230 and one or more memory devices 240. In some examples, memory device(s) 240 store instructions that, when executed by physical processor(s) 230, cause physical processor(s) 230 to perform one or more of the disclosed steps. For example, memory device(s) 240 can include modules 242, which can be implemented via hardware and/or software, to respectively perform the steps described herein. In some embodiments, computing device 202 and/or server 206 can receive scene rig captures 220 and face rig captures 222 and can process the scene rig captures 220 and the face rig captures 222 to generate dynamic reconstructions and paired detail-enhanced training data.

In some embodiments, computing device 202 and/or server 206 are configured to reconstruct four-dimensional Gaussian splatting models from the scene rig captures 220, construct low-quality and high-quality Gaussian splatting models from the face rig captures 222, render paired image sequences (e.g., along specified virtual camera trajectories), and train a diffusion-based detail enhancement model using the paired image sequences. In some examples, computing device 202 and/or server 206 apply the trained diffusion-based detail enhancement model to rasterized outputs of the reconstructed dynamic performances to produce detail-enhanced red-green-blue (RGB) and alpha images suitable for compositing.

In certain implementations, the modules 242 include a calibration module to estimate camera intrinsics/extrinsics and spatially varying exposure and/or black-level grids, a reconstruction module to initialize and control time-varying Gaussian primitives, a rendering module to produce linear high dynamic range RGB frames with antialiasing enabled, a temporal conditioning module to compute optical flow warps and/or validity masks, a training module to adapt the detail enhancement model for joint RGB/alpha prediction, and a compositing/export module to output production-ready frames.

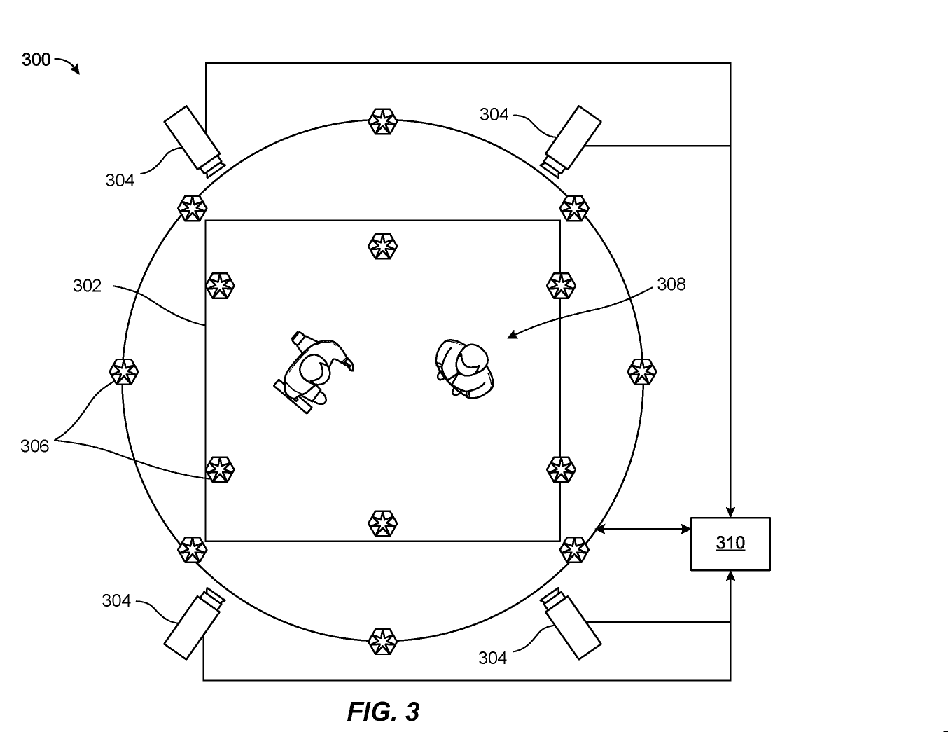

FIG. 3 is a diagram illustrating a scene rig 300 for capturing a multi-actor performance, according to at least one embodiment of the present disclosure.

In some embodiments, scene rig 300 includes a stage 302, scene cameras 304, lights 306, multiple actors 308, and a computing device 310 to enable volumetric image data capture. For example, scene rig 300 is configured to support both static and dynamic capture setups while ensuring spatial and temporal coherence in the recorded data. Scene rig 300 accommodates advanced lighting arrangements and camera mobility to enhance footage quality for subsequent reconstruction and enhancement processes.

In some embodiments, stage 302 can operate as the central performance area within scene rig 300. Stage 302 can be implemented as a raised platform or as an area of a flat floor, depending on specific capture requirements. For example, stage 302 is designed to provide sufficient space for multiple actors to perform actions such as walking, running, gesturing, and/or interacting with each other and/or props. Stage 302 is surrounded by scene cameras 304 and lights 306 to ensure comprehensive coverage and substantially uniform illumination (or another illumination setup, depending on production requirements). In some examples, calibration patterns can be placed on or adjacent to stage 302 to facilitate camera alignment and accurate volumetric reconstruction. Stage 302 is constructed to reduce occlusions and support visibility of multiple actors 308 from multiple viewpoints.

In some embodiments, scene cameras 304 are strategically positioned around stage 302 to capture multi-view footage of the performances. Scene cameras 304 can include statis and dynamic cameras. Static cameras provide a wide field of view, and dynamic cameras include pan, tilt, zoom, and focus capabilities to track actor movements. For example, scene cameras 304 are synchronized to capture high-resolution footage at consistent frame rates, such as, but not limited to, 4K resolution at 24 frames per second. Calibration of scene cameras 304 can be performed using lidar scans and reference frames to ensure accurate alignment and to reduce internal and external ambiguities. The footage captured by scene cameras 304 serves as the input for dynamic reconstruction processes, including four-dimensional Gaussian splatting.

In some embodiments, lights 306 are distributed throughout scene rig 300 to provide uniform illumination across the stage 302. Lights 306 can include white LED fixtures mounted on the ceiling, walls, and mobile carts surrounding the stage 302. Lights 306 are synchronized with scene cameras 304 to emit short-duration strobes timed to camera shutters, which can reduce motion blur while maintaining actor comfort. The lighting setup is configured to reduce shadows and ensure consistent exposure across all captured views. Lights 306 can support high dynamic range (HDR) rendering to enhance color fidelity during reconstruction and rendering processes.

In some embodiments, multiple actors 308 perform dynamic actions on the stage 302, which are captured by scene cameras 304. These actions can include walking, running, gesturing, and/or interacting with props and/or other actors. To improve tracking accuracy, unobtrusive motion-capture markers can be affixed to actors’ clothing, for example, below the back of the neck. Performances of multiple actors 308 are recorded in high resolution and serve as the basis for volumetric reconstruction using four-dimensional Gaussian splatting. Multiple actors 308 can perform multiple takes to ensure adequate coverage for subsequent detail enhancement and compositing stages.

In some embodiments, computing device 310 is connected to scene cameras 304 and lights 306 and serves as the central processing unit for scene rig 300. Computing device 310 manages synchronization of cameras 304 and lights 306, processing captured footage, and performing dynamic reconstruction using advanced algorithms such as four-dimensional Gaussian splatting. Computing device 310 can include specialized modules for camera calibration, exposure and black-level optimization, and/or rendering. The computing device 310 is also used to generate virtual camera trajectories and frame preferences for downstream detail enhancement and/or compositing stages. Computing device 310 ensures that captured data is processed efficiently and accurately to produce high-quality volumetric reconstructions suitable for professional media production.

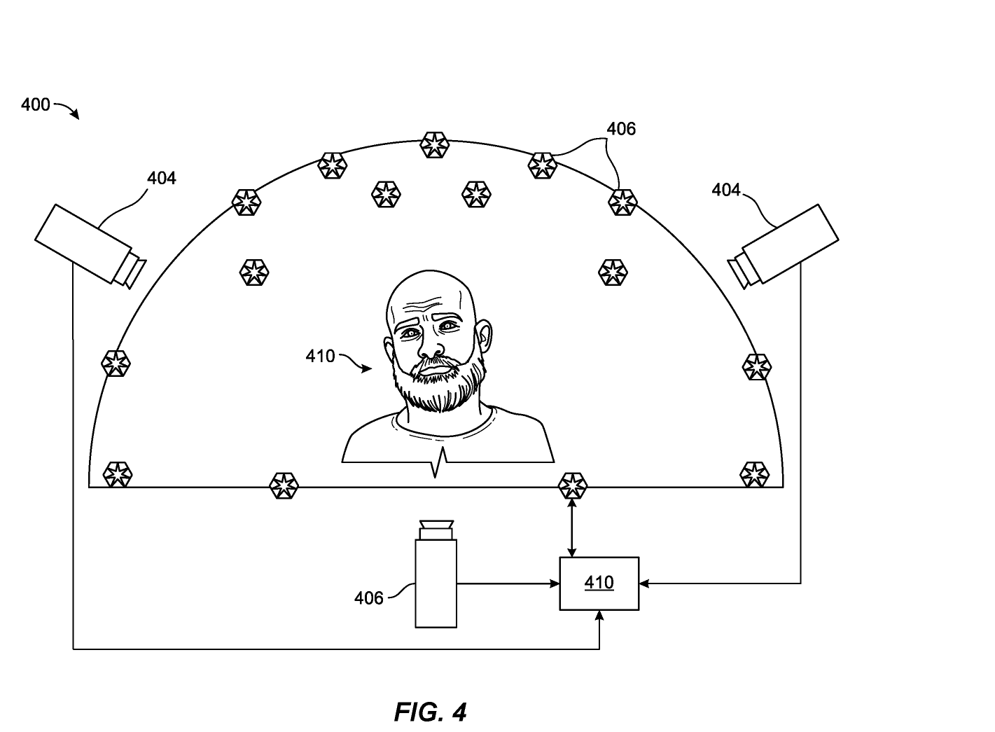

FIG. 4 is a diagram illustrating a face rig 400 for capturing single-actor facial detail, according to at least one embodiment of the present disclosure.

In some embodiments, face rig 400 can operate as a specialized volumetric capture system configured to acquire high-resolution facial data of a single actor 410, such as each of the multiple actors 308 whose performance was captured in scene rig 300. Accordingly, face rig 400 enables the capture of detailed facial features and expressions for use in the diffusion-based video generation pipeline. The enclosure of face rig 400 can be dome-like or cylindrical in form, designed for capturing multi-view images (e.g., still images and/or video images) of the actor’s face and upper body with high fidelity. For example, face rig 400 can include multiple face cameras 404 and lights 406, which are strategically positioned to ensure comprehensive coverage and uniform illumination of the face of the single actor 410.

In some embodiments, face cameras 404 include an array of synchronized high-resolution cameras distributed around the interior of face rig 400. These cameras can be mounted at fixed locations and angles to provide dense multi-view coverage of the actor’s face and upper body. By way of example and not limitation, the array can include approximately seventy-five face cameras 404, evenly distributed around the cylindrical structure, including top-down views from cameras mounted on the ceiling. Additionally, the cameras can be equipped with fixed focal lengths and calibrated baselines to ensure accurate multi-view geometry. For example, the face cameras 404 can capture 4K resolution images at 24 frames per second, thereby enabling acquisition of fine facial details such as skin texture, hair strands, freckles, and micro-expressions. Furthermore, the captured data can be processed to generate high-quality Gaussian splatting models, which serve as ground truth for training the diffusion-based detail enhancement model.

In some examples, lights 406 can include an array of white LED fixtures distributed throughout face rig 400 to provide consistent and uniform illumination. These lights 406 can be configured to emit flat, diffuse lighting, which is useful for capturing fine facial details without introducing harsh shadows and/or reflections. In some embodiments, lights 406 operate in short-duration strobes synchronized with shutters of the face cameras 404 to reduce motion blur while preserving skin microdetails. The lighting setup ensures that the captured images are of high quality and suitable for downstream processing, including color calibration and detail enhancement. Accordingly, lights 406 can be evenly distributed across the walls and ceiling of face rig 400 to secure uniform lighting across the actor’s face and upper body.

In some embodiments, the single actor 410 is positioned at the center of face rig 400 during the capture process. Single actor 410 can perform a series of facial expressions and micro-expressions such as smiling, frowning, raising eyebrows, and/or opening or closing the mouth to provide a diverse range of facial data. Additionally, the position of single actor 410 can be carefully calibrated to ensure optimal alignment with both face cameras 404 and lights 406. The data captured from single actor 410 can be used to create high-quality Gaussian splatting models that are used for training the diffusion-based detail enhancement model. As a result, the facial data also improves the quality of facial closeups in the final video output, ensuring high fidelity and temporal stability.

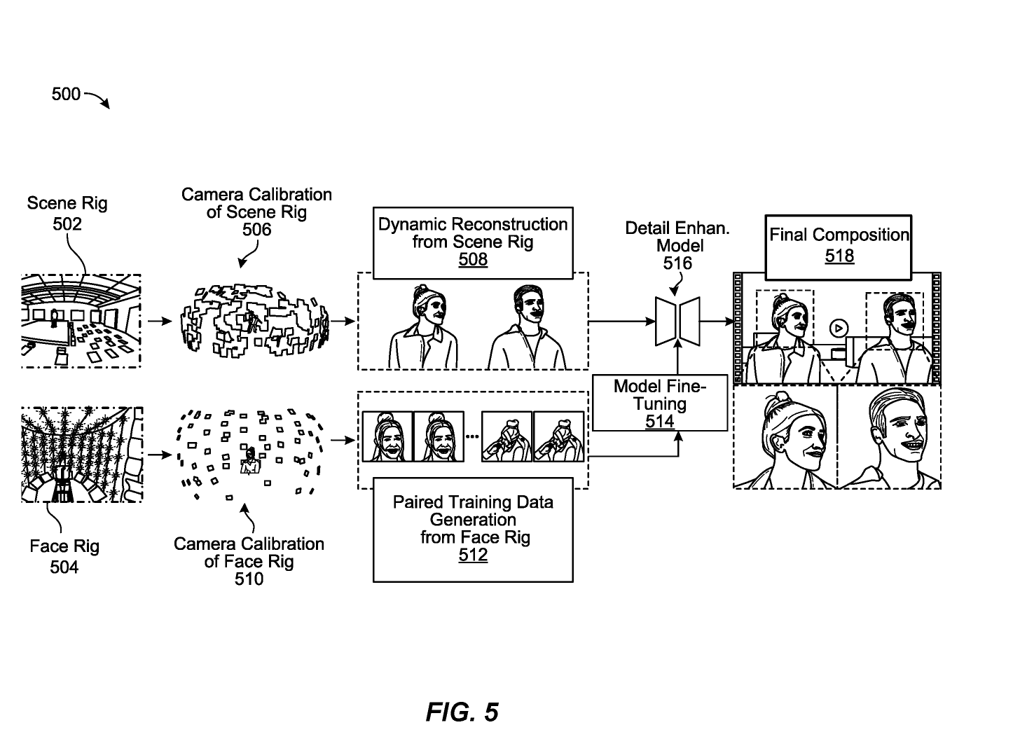

FIG. 5 is a flow diagram illustrating a pipeline 500 for generating detail-enhanced videos, according to at least one embodiment of the present disclosure.

Pipeline 500 can serve as a detail enhancement framework for video generation, integrating data capture, calibration, reconstruction, training, and enhancement stages. In some embodiments, the pipeline 500 combines inputs from two distinct capture systems, scene rig 502 and face rig 504, to produce high-quality, detail-enhanced video outputs. For example, by addressing the challenges of maintaining high fidelity and temporal stability in dynamic, multi-actor environments, pipeline 500 enables consistent, production-ready results. This framework ensures that all stages cooperate to deliver temporally stable, high-resolution video.

In some respects, scene rig 502 can be the same as or similar to scene rig 300 discussed above. For example, scene rig 502 can function as a large-scale volumetric capture system designed to record multi-actor performances over a wide area. Scene rig 502 can include a combination of static and dynamic cameras strategically positioned around a stage to capture multi-view footage of actors performing various actions. For example, static cameras provide wide field of view coverage, and dynamic cameras equipped with pan, tilt, zoom, and focus capabilities track actors’ movements. Scene rig 502 is configured to capture dynamic performances with high spatial detail and temporal coherence, although the resolution achieved is not sufficient for production-quality facial closeups. The data captured by the scene rig 502 then serves as the primary input for dynamic reconstruction 508.

In some embodiments, camera calibration 506 of scene rig 502 can ensure accurate alignment and synchronization of the static and dynamic cameras within scene rig 502. This calibration process includes estimating camera internal and external parameters, as well as compensating for exposure and baseline-level variations to address lens glare and sensor variability. The calibration process plays a role in generating accurate multi-view data, which is used in the dynamic reconstruction 508. Calibrated data is geometrically consistent and suitable for downstream processing.

In some embodiments, dynamic reconstruction 508 from scene rig 502 can involve processing the multi-view footage captured by scene rig 502 to create a four-dimensional Gaussian splatting model. For example, this model represents the dynamic scene using time-varying Gaussian primitives, which are mathematical representations of spatial data. The reconstruction process includes initializing dense per-frame point clouds, parameterizing Gaussian primitives, and ensuring temporal coherence across frames. The resulting four-dimensional Gaussian splatting model provides a temporally stable, color-accurate representation of dynamic performances, which then serves as the input for a detail enhancement model 516.

In some respects, face rig 504 can be the same as, or similar to, face rig 400 described above. For example, face rig 504 can function as a specialized volumetric capture system designed to acquire high-resolution facial data from individual actors. Face rig 504 can include a cylindrical or dome-like enclosure equipped with a dense array of synchronized high-resolution cameras. These cameras are strategically positioned to capture multi-view images of the actor’s face and upper body with high fidelity. Face rig 504 records a diverse range of facial expressions and micro-expressions, providing high-quality data for training the detail enhancement model 516. The data captured by face rig 504 is subsequently processed in paired training data generation 512.

In some embodiments, camera calibration 510 of face rig 504 can ensure precise alignment and synchronization of the cameras within face rig 504. This calibration process includes determining the internal and external parameters of each camera, as well as ensuring consistent color calibration as compared with scene rig 502. The calibration process plays a role in generating accurate multi-view facial data, which is used in the paired training data generation 512. The calibrated data ensures that high-resolution facial details are accurately captured and aligned for subsequent processing.

In some embodiments, paired training data generation 512 from face rig 504 can involve creating a dataset of low-quality and high-quality Gaussian splatting models for each actor. The low-quality models are designed to emulate the quality of scene rig 502, and the high-quality models achieve greater fidelity by using a higher number of Gaussian primitives. For example, the low-quality models can be a degraded form of the high-quality models, such as by using a lower number of Gaussian primitives. Both models are rendered along identical virtual camera trajectories to produce paired image sequences with pixel-level correspondence. These paired sequences serve as training data for the detail enhancement model 516, enabling the detail enhancement model 516 to learn how to map low-quality inputs to high-quality outputs.

In some embodiments, model fine-tuning 514 can involve training the detail enhancement model 516 using the data from paired training data generation 512. The fine-tuning process adapts a pre-trained image diffusion model to accept multiple conditioning inputs, such as low-quality RGB and alpha channels, warped versions of previous frames, and warp validity masks. The model is trained to jointly predict high-resolution RGB and alpha channels, ensuring that the enhanced outputs are temporally stable and suitable for compositing.

In some embodiments, detail enhancement model 516 can function as a diffusion-based machine learning framework designed to enhance the quality of the dynamic reconstructions from scene rig 502. The detail enhancement model 516 takes as input the renderings from the four-dimensional Gaussian splatting model generated in dynamic reconstruction 508, along with additional conditioning inputs such as the warped previous frame and the validity mask associated with the previous frame. The detail enhancement model 516 also takes as inputs the paired low-quality and high-quality renderings (e.g., both RGB and alpha renderings) from the paired training data generation 512. The detail enhancement model 516 produces detail-enhanced RGB and alpha channels, ensuring that fine details such as hair strands and facial features are rendered with precision. The enhanced outputs maintain temporal stability and align seamlessly with the underlying volumetric geometry.

In some embodiments, a final composition 518 can involve integrating the detail-enhanced outputs from detail enhancement model 516 into a final video. The enhanced RGB and alpha channels are composited with background elements to create production-quality video frames. In some examples, the final composition 518 supports 4K resolution and is suitable for professional media production, including cinematic closeups and dynamic scenes. The process is designed to ensure that the enhanced details remain consistent across frames, delivering a high level of photorealism and temporal stability.

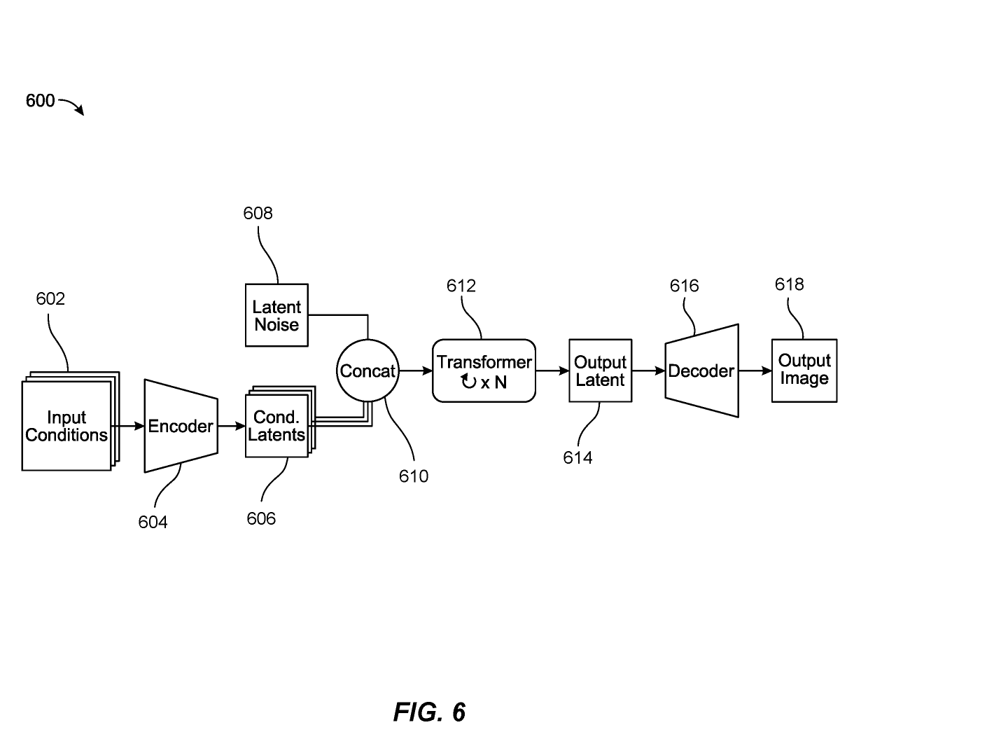

FIG. 6 is a block diagram showing a process 600 for generating detail-enhanced videos, according to at least one embodiment of the present disclosure.

In some embodiments, process 600 can function as a diffusion-based image generation pipeline and can be instantiated entirely in software and/or distributed across computing modules. Accordingly, process 600 integrates multiple components including input conditions 602, an encoder 604, conditioned latents 606, latent noise 608, concatenation 610, a transformer 612, an output latent 614, a decoder 616, and a final output image 618 to transform raw inputs into a high-quality, detail-enhanced image. For example, each component cooperates to successively condition, refine, and decode representations, where the primary objective is to produce output image 618 in accordance with specified spatial, temporal, and fidelity characteristics.

As used herein, the term “image” refers to a visual representation of an object, scene, or subject, which can be captured, generated, or displayed in various formats. It encompasses both individual static images, such as digital pictures, and/or a series of sequential images, such as those found in video footage, where the sequence creates the perception of motion over time. Accordingly, process 600 can be performed to produce single images and/or multiple images (e.g., videos).

In some examples, input conditions 602 can include low-quality RGB images, low-quality alpha images, a warped version of a previously generated frame, and a corresponding warp validity mask. These inputs can play a role in conditioning the model to achieve temporal stability, spatial consistency, and enhanced detail. Additionally, input conditions 602 are encoded into a latent representation by encoder 604, thereby enabling downstream modules to operate on a compact, semantically rich data format.

In some embodiments, encoder 604 can be realized as a variational autoencoder (VAE) and/or a comparable neural network architecture. The encoder 604 processes input conditions 602 to generate conditioned latents 606, extracting high-level features and encapsulating them within a reduced-dimensional latent space. As a result, encoder 604 ensures that the input data is formatted and prepared for integration with inputs in subsequent stages.

Conditioned latents 606, as produced by encoder 604, represent the encoded features of input conditions 602 including spatial, temporal, and contextual information for image synthesis. In some examples, conditioned latents 606 are combined with latent noise 608 during concatenation 610 to introduce variability and to foster the generation of novel details within output image 618.

In some embodiments, latent noise 608 includes a randomly sampled noise vector that serves as the starting point for a video and/or image diffusion process. Latent noise 608 is progressively denoised and refined throughout the pipeline to impart stochastic variations into the final image.

Concatenation 610 combines conditioned latents 606 and latent noise 608 into a single input tensor, ensuring that downstream modules have simultaneous access to both the encoded input conditions and the stochastic variability. The concatenated tensor is then provided to transformer 612 for further processing.

In some embodiments, transformer 612 includes multiple layers of attention mechanisms and feed-forward networks, denoted ×N where N represents the number of layers. The transformer 612 refines the concatenated tensor by progressively denoising the latent noise 608 and integrating information from conditioned latents 606. For example, through iterative attention operations, transformer 612 generates output latent 614, which encapsulates high-level features and refined details for image decoding.

Output latent 614, as produced by transformer 612, serves as the refined latent representation that contains all features for constructing the final output image 618. Output latent 614 is passed to decoder 616, which translates the latent into pixel space to produce output image 618.

In some examples, decoder 616 is implemented as a convolutional decoder and/or a similar neural network architecture. Decoder 616 processes output latent 614 to generate output image 618, ensuring that the image is high-resolution, detail-enhanced, and consistent with input conditions 602.

Output image 618 represents the concluding result of process 600. This output image 618 is a high-resolution, detail-enhanced rendering that aligns with input conditions 602 and incorporates stochastic variations introduced by latent noise 608. In some embodiments, output image 618 is suitable for cinematic productions, virtual reality environments, and customized video generation applications, where high fidelity and temporal stability are desired.

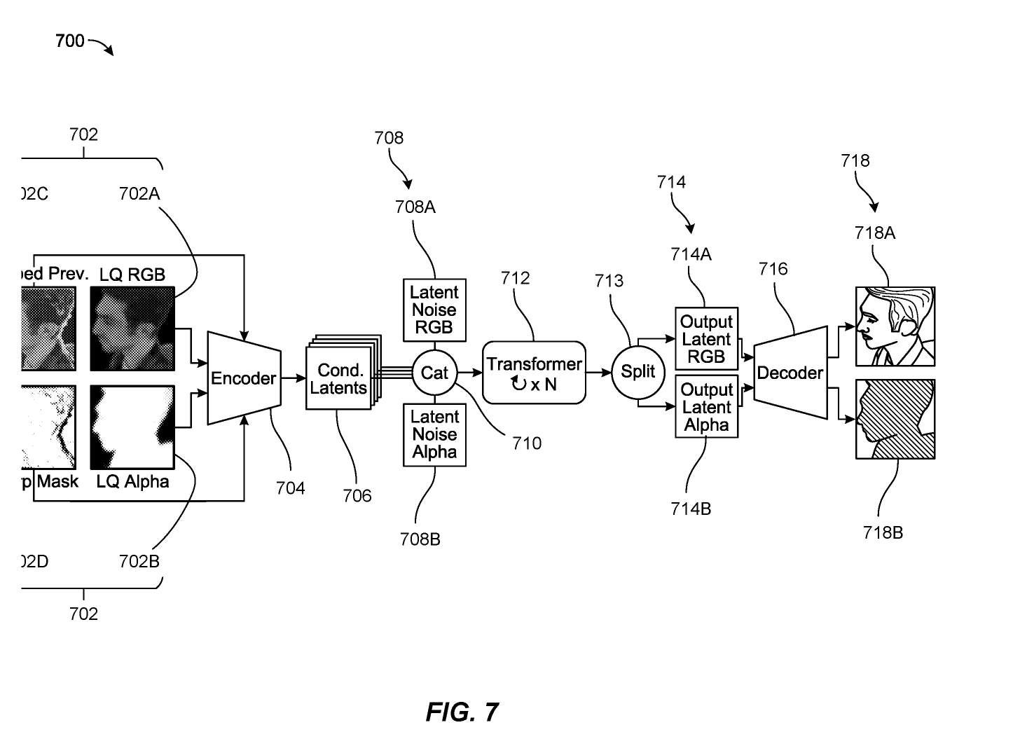

FIG. 7 is a block diagram showing an example implementation of a process 700 for generating detail-enhanced videos, according to at least one embodiment of the present disclosure. For example, process 700 can be regarded as an example implementation of process 600 described above in reference to FIG. 6.

As shown in FIG. 7, process 700 can be performed to transform inputs into high-quality, detail-enhanced output images. Process 700 includes input conditions 702, encoder 704, conditioned latents 706, latent noise 708, concatenation 710, transformer 712, split 713, decoder 716, and output images 718. The following description provides a detailed overview of each of these inputs, modules, and outputs, and the role played by each in the video generation pipeline.

Input conditions 702 serve as the foundational data for the video generation process. Input conditions 702 include multiple components that provide information for generating high-quality, detail-enhanced video frames. For example, LQ RGB frames 702A include low-quality red-green-blue (RGB) image frames derived from the initial gaussian splatting process. These frames convey the color information of the scene at a quality that substantially matches closeup data from multi-actor scene performances. LQ alpha frames 702B encode transparency information via an alpha channel of the low-quality input, which plays a role in compositing the subject onto different backgrounds and preserving fine details such as hair strands and edges. A warped version 702C denotes a warped rendition of the previously generated high-quality frame. The warping is performed using optical flow techniques to align the previous frame with the current frame, thereby supporting temporal consistency and reducing flickering artifacts. A warp validity mask 702D identifies regions where the warping process is reliable, guiding the model in determining which areas of the warped frame can be trusted.

Encoder 704 processes the input conditions 702 to extract high-level features and encode them into a compact latent representation. Encoder 704 operates on both the LQ RGB frames 702A and LQ alpha frames 702B, as well as the warped version 702C and warp validity mask 702D, to generate conditioned latents 706. The input data is transformed into a format suitable for downstream processing.

Conditioned latents 706 are the output of encoder 704 and encapsulate the spatial, temporal, and contextual information extracted from the input conditions 702. These conditioned latents 706 serve as an input for subsequent stages of the video generation process, ensuring that the model has access to all pertinent information for generating high-quality outputs.

Latent noise 708 introduces stochastic variations into the video generation process to enable the creation of novel details and enhance the realism of the output. In this example, latent noise 708 includes two components. Latent noise RGB 708A introduces variability in the RGB channels to allow the model to generate detailed and realistic color information, and latent noise alpha 708B introduces variability in the alpha channel to ensure that the transparency information is consistent and aligned with the RGB details.

The concatenation 710 combines conditioned latents 706 with latent noise 708 into a single input tensor. This step ensures that transformer 712 has simultaneous access to both the encoded input conditions and the stochastic variations introduced by latent noise 708.

Transformer 712 is a multi-layer neural network that processes the concatenated tensor produced by concatenation 710. Transformer 712 refines the combined information through iterative attention mechanisms and feed-forward networks, progressively reducing the latent noise and incorporating the information derived from the conditioned latents 706.

Following refinement by transformer 712, the split 713 divides the output of transformer 712 into two separate latent representations. Output latent RGB 714A contains the refined features for generating the RGB image with enhanced quality, while output latent alpha 714B contains the refined features for generating the alpha channel with enhanced quality.

Decoder 716 translates the output latents 714 into pixel-space images. Decoder 716 processes output latent RGB 714A and output latent alpha 714B independently to generate the final detail-enhanced images.

The output images 718 represent the final result of the video generation process. These detail-enhanced images include two components. Output RGB image 718A is the high-quality, detail-enhanced RGB image including refined color and texture details, and output alpha image 718B is the high-quality, detail-enhanced alpha channel encoding transparency information. The output alpha image 718B supports compositing the subject onto different backgrounds and preserving fine details such as edges and hair strands.

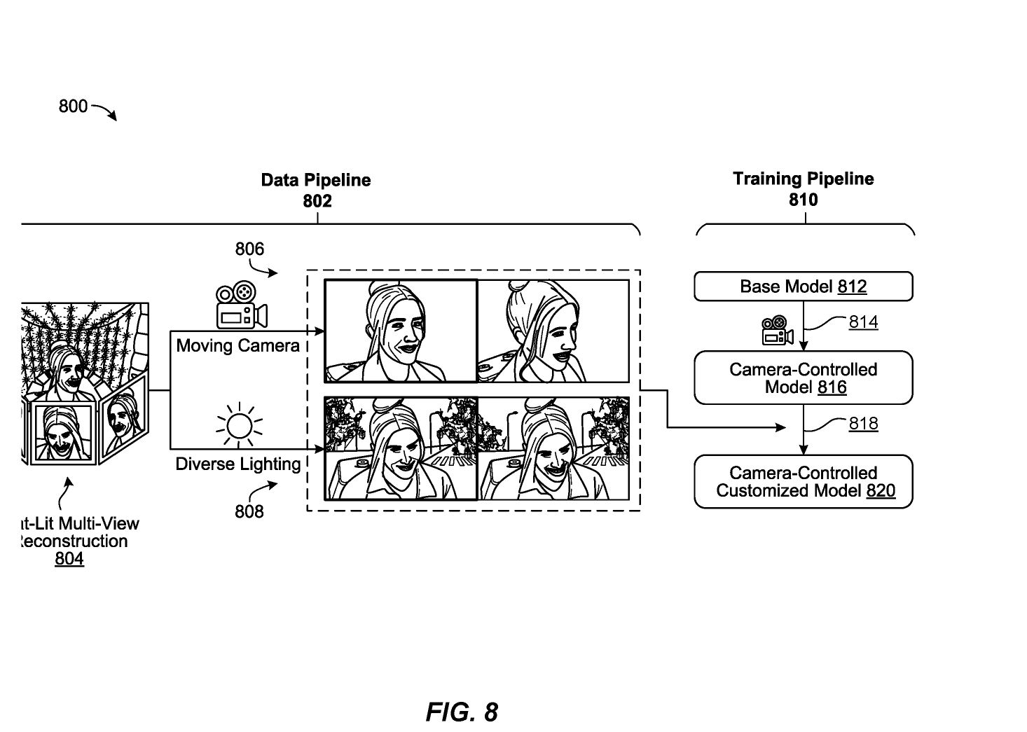

FIG. 8 is a block diagram showing a process 800 for generating videos along a specified trajectory, according to at least one embodiment of the present disclosure.

In some embodiments, process 800 includes a data pipeline 802 and a training pipeline 810. Process 800 is configured to generate high-quality, camera-controlled, and identity-consistent videos by leveraging multi-view data, camera pretraining 814, and multi-view customization 818 techniques. Data pipeline 802 includes preparation of the training data that is provided to the training pipeline 810, where models are trained and fine-tuned for video generation.

For example, data pipeline 802 includes flat-lit multi-view reconstruction 804, moving camera rendered videos 806, and diverse lighting rendered videos 808. These stages ensure that the training data captures a wide range of perspectives, camera motions, and lighting conditions, which contribute to training robust and versatile video generation models.

In data pipeline 802, flat-lit multi-view reconstruction 804 is performed based on video and/or image captures from a scene rig and/or face rig (e.g., as described above) one or more subjects in a controlled environment with flat and diffuse lighting to ensure uniform illumination. The captured data is processed using 4D Gaussian Splatting (4DGS) to create high-fidelity multi-view reconstructions of the subject(s), which serve as a foundation for generating diverse training data.

Moving camera rendered videos 806 are then generated by rendering the 4DGS reconstructions along diverse camera trajectories. For example, these trajectories simulate realistic camera movements including pans, tilts, and zooms to capture the subject from various angles and perspectives. This stage ensures that the training data incorporates dynamic camera motion, which is useful for training models to generate videos with accurate and reliable camera control.

Diverse-lighting rendered videos 808 are created by applying a generalizable video relighting model to the 4DGS reconstructions. In some embodiments, this stage introduces lighting variability by simulating different lighting conditions, such as changes in intensity, direction, and/or color temperature. The inclusion of diverse lighting conditions in the training data contributes to enhancing the model’s ability to adapt to various lighting scenarios, improving the realism and versatility of the generated videos.

In some embodiments, training pipeline 810 utilizes the data generated by data pipeline 802 to train and fine-tune one or more video generation models. The training pipeline includes base model 812, camera pretraining 814, camera-controlled model 816, multi-view customization 818, and camera-controlled customized model 820. Each stage builds upon the previous one to progressively enhance the model’s capabilities.

Base model 812 serves as the starting point for training pipeline 810. In some embodiments, base model 812 is a pre-trained video generation model trained on large, general-purpose datasets to learn foundational capabilities such as generating coherent frames and maintaining temporal consistency.

Camera pretraining 814 adapts base model 812 to recognize and utilize camera parameters, including 3D positions, orientations, and/or properties associated with the camera. For example, this camera pretraining 814 can involve training the base model 812 on datasets with annotated camera trajectories, thereby enabling the model to generate videos that align with specified camera motions. Camera pretraining 814 plays a role in achieving precise camera control in subsequent stages.

Camera-controlled model 816 is the result of camera pretraining 814. In some embodiments, this camera-controlled model 816 is capable of generating videos with accurate camera control, following the input camera trajectories provided during training. Camera-controlled model 816 serves as the basis for further customization to incorporate subject-specific details and multi-view identity preservation.

Multi-view customization 818 fine-tunes camera-controlled model 816 using subject-specific multi-view data generated in data pipeline 802. In some embodiments, this stage ensures that the model can generate videos preserving the subject’s identity across multiple viewpoints and under dynamic camera motion. The customization process involves associating the subject(s) with a respective distinct token embedded in input prompts, thereby allowing the model to learn the subject’s specific appearance and characteristics.

Camera-controlled customized model 820 represents the final output of training pipeline 810. In some embodiments, this camera-controlled customized model integrates the functionalities of camera-controlled model 816 with the subject-specific details acquired during multi-view customization 818. Camera-controlled customized model 820 can be capable of producing high-quality, identity-consistent videos with precise camera control and adaptability to various lighting conditions, rendering the model appropriate for applications such as cinematic productions, virtual reality, and personalized video generation.

Accordingly, the present disclosure includes a large-scale multi-actor capture, dynamic 4D Gaussian splatting reconstruction, and a diffusion-based detail enhancement model trained on paired low- and high-quality facial data. A scene rig records temporally coherent performances with static and dynamically aimed cameras, while a face rig acquires high-fidelity facial detail used to supervise enhancement of closeups. The reconstruction stage includes stable calibration for moving cameras, HDR-aware color handling, and/or exposure/black-level optimization to improve color fidelity. The enhancement stage jointly predicts RGB and alpha with temporal conditioning and low-frequency stabilization, delivering outputs suitable for compositing. Together, these components provide production-grade subject fidelity, multi-view consistency, precise virtual camera control, and scalable workflows for professional media creation.

The following example embodiments are also included in the present disclosure.

Example 1. A method, including: capturing multi-actor performances using a scene rig including a stage and multiple scene cameras; reconstructing dynamic performances from the scene rig using four-dimensional Gaussian splatting; capturing single-actor facial detail using a face rig including multiple face cameras; constructing, for each actor for which single-actor facial detail is captured, a low-quality (LQ) Gaussian splatting model and a high-quality (HQ) Gaussian splatting model based on the captured single-actor facial detail; rendering the LQ and HQ Gaussian splatting models to produce paired image sequences for each actor for which single-actor facial detail is captured; training a diffusion-based detail enhancement model using the paired image sequences; and rendering HQ images for facial closeups by applying the trained diffusion-based detail enhancement model to the reconstructed dynamic performances.

Example 2. The method of Example 1, wherein the LQ Gaussian splatting model includes between 50,000 and 200,000 Gaussians per frame and the HQ Gaussian splatting model includes 1 million or more Gaussians per frame.

Example 3. The method of Example 1 or Example 2, wherein reconstructing the dynamic performances includes correcting spatially variable exposure and black-level values to compensate for lens glare and sensor variability in the captured multi-actor performances.

Example 4. The method of any one of Examples 1 through 3, wherein the multiple scene cameras include stationary scene cameras positioned at various locations around the stage and dynamic scene cameras that perform pan, tilt, zoom, and focus adjustments based on the multi-actor performances.

Example 5. The method of Example 4, wherein capturing the multi-actor performances further includes tracking movement of multiple actors with the dynamic scene cameras using motion-capture markers affixed to the multiple actors.

Example 6. The method of Example 4 or Example 5, further including: calibrating the multiple scene cameras in the scene rig by: calibrating only the stationary scene cameras using lidar scans while keeping focal lengths of the stationary scene cameras fixed; after calibrating only the stationary scene cameras, fixing positions of the stationary scene cameras in the scene rig; and after calibrating only the stationary scene cameras, separately calibrating the dynamic scene cameras.

Example 7. The method of Example 6, wherein calibrating the dynamic scene cameras includes: fitting a smooth function to changes in focal length provided by the dynamic scene cameras and using the smooth function as a regularization across frames to account for zoom changes and to reduce inconsistencies in calibration.

Example 8. The method of any one of Examples 1 through 7, wherein: capturing the multi-actor performances includes capturing a color chart; capturing the single-actor facial detail includes capturing the color chart; and the method further includes: calibrating the color of the captured multi-actor performances and of the captured single-actor facial detail to each other using the captured color chart.

Example 9. The method of any one of Examples 1 through 8, wherein capturing the multi-actor performances includes capturing multiple actors performing a variety of actions on the stage.

Example 10. The method of any one of Examples 1 through 9, wherein capturing the single-actor facial detail includes capturing a single actor performing a variety of facial expressions.

Example 11. The method of any one of Examples 1 through 10, wherein: rendering the LQ and HQ Gaussian splatting models to produce paired image sequences for each actor for which single-actor facial detail is captured includes: rendering LQ red-green-blue (RGB) images and LQ alpha images from the LQ Gaussian splatting model; and rendering HQ RGB images and HQ alpha images from the HQ Gaussian splatting model; and training the diffusion-based detail enhancement model using the paired image sequences includes: comparing a current output frame of the HQ RGB images to a previous output frame of the HQ RGB images to generate a warped version of the previous output frame and a warp validity mask; and conditioning the diffusion-based detail enhancement model using the LQ RGB images, LQ alpha images, warped version of the previous output frame, and warp validity mask.

Example 12. The method of any one of Examples 1 through 11, wherein rendering the HQ images for facial closeups by applying the trained diffusion-based detail enhancement model includes outputting detail-enhanced red-green-blue (RGB) images and detail-enhanced alpha images for alpha compositing.

Example 13. A method, including: capturing, using a face rig including a plurality of face cameras, detailed images of an actor’s face performing various facial expressions; capturing, using a scene rig including a plurality of scene cameras, full-body performances of the actor; reconstructing, via four-dimensional Gaussian splatting, a time-varying volumetric representation of the actor based on the captured detailed images from the face rig and the captured full-body performances from the scene rig; rendering, from the volumetric representation and along simulated camera trajectories, a plurality of two-dimensional video sequences of the actor to produce a multi-view training dataset paired with associated camera parameters; fine-tuning a pretrained video generation model on the multi-view training dataset and the associated camera parameters to create a customized video generation model associated with the actor while preserving identity consistency across varying viewpoints; and generating, by providing the customized video generation model with a token associated with the actor and a specified camera trajectory, an actor-specific video output that follows the specified camera trajectory and that maintains coherent multi-view identity of the actor.

Example 14. The method of Example 13, further including applying a video relighting model to the rendered two-dimensional video sequences to generate relighted video sequences, wherein the multi-view training dataset further includes the relighted video sequences.

Example 15. The method of Example 13 or Example 14, wherein the multi-view training dataset is augmented by rendering the volumetric representation along a plurality of diverse camera trajectories generated by randomly sampling starting and ending positions within a specified radius and interpolating between the starting and ending positions to create smooth motion paths.

Example 16. The method of any one of Examples 13 through 15, wherein generating the actor-specific video output further includes providing a text prompt to the customized video generation model.

Example 17. The method of any one of Examples 13 through 16, wherein the plurality of face cameras include face cameras respectively positioned to capture the actor’s face from a front of the face and from sides of the face.

Example 18. The method of any one of Examples 13 through 17, further including pretraining a video generation model to obtain the pretrained video generation model, wherein the pretraining includes training the video generation model to recognize three-dimensional camera positions and parameters as input.

Example 19. The method of Example 18, wherein the video generation model includes a video diffusion model.

Example 20. A system, including: at least one physical processor; and physical memory including computer-executable instructions that, when executed by the physical processor, cause the physical processor to: reconstruct, from captured multi-actor performances of multiple actors in a scene rig including a stage and multiple scene cameras, dynamic performances using four-dimensional Gaussian splatting; construct, for each actor of the multiple actors and from captured single-actor facial detail in a face rig including multiple face cameras, a low-quality (LQ) Gaussian splatting model and a high-quality (HQ) Gaussian splatting model; render the LQ and HQ Gaussian splatting models to produce paired image sequences for each actor; train a diffusion-based detail enhancement model using the paired image sequences; and render HQ images for facial closeups by applying the trained diffusion-based detail enhancement model to the reconstructed dynamic performances from the scene rig.

As detailed above, the computing devices and systems described and/or illustrated herein broadly represent any type or form of computing device or system capable of executing computer-readable instructions, such as those contained within the modules described herein. In their most basic configuration, these computing device(s) can each include at least one memory device and at least one physical processor.

In some examples, the term “memory device” generally refers to any type or form of volatile or non-volatile storage device or medium capable of storing data and/or computer-readable instructions. In one example, a memory device can store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations, or combinations of one or more of the same, or any other suitable storage memory.

In some examples, the term “physical processor” generally refers to any type or form of hardware-implemented processing unit capable of interpreting and/or executing computer-readable instructions. In one example, a physical processor can access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein can represent portions of a single module or application. In addition, in certain embodiments one or more of these modules can represent one or more software applications or programs that, when executed by a computing device, can cause the computing device to perform one or more tasks. For example, one or more of the modules described and/or illustrated herein can represent modules stored and configured to run on one or more of the computing devices or systems described and/or illustrated herein. One or more of these modules can also represent all or portions of one or more special-purpose computers configured to perform one or more tasks.

In addition, one or more of the modules described herein can transform data, physical devices, and/or representations of physical devices from one form to another. Additionally or alternatively, one or more of the modules recited herein can transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method, comprising:
capturing multi-actor performances using a scene rig including a stage and multiple scene cameras;
reconstructing dynamic performances from the scene rig using four-dimensional Gaussian splatting;
capturing single-actor facial detail using a face rig including multiple face cameras;
constructing, for each actor for which single-actor facial detail is captured, a low-quality (LQ) Gaussian splatting model and a high-quality (HQ) Gaussian splatting model based on the captured single-actor facial detail;
rendering the LQ and HQ Gaussian splatting models to produce paired image sequences for each actor for which single-actor facial detail is captured;
training a diffusion-based detail enhancement model using the paired image sequences; and
rendering HQ images for facial closeups by applying the trained diffusion-based detail enhancement model to the reconstructed dynamic performances.

2. The method of claim 1, wherein the LQ Gaussian splatting model comprises between 50,000 and 200,000 Gaussians per frame and the HQ Gaussian splatting model comprises 1 million or more Gaussians per frame.

3. The method of claim 1, wherein reconstructing the dynamic performances comprises correcting spatially variable exposure and black-level values to compensate for lens glare and sensor variability in the captured multi-actor performances.

4. The method of claim 1, wherein the multiple scene cameras comprise stationary scene cameras positioned at various locations around the stage and dynamic scene cameras that perform pan, tilt, zoom, and focus adjustments based on the multi-actor performances.

5. The method of claim 4, wherein capturing the multi-actor performances further comprises tracking movement of multiple actors with the dynamic scene cameras using motion-capture markers affixed to the multiple actors.

6. The method of claim 4, further comprising:
calibrating the multiple scene cameras in the scene rig by:
calibrating only the stationary scene cameras using lidar scans while keeping focal lengths of the stationary scene cameras fixed;
after calibrating only the stationary scene cameras, fixing positions of the stationary scene cameras in the scene rig; and
after calibrating only the stationary scene cameras, separately calibrating the dynamic scene cameras.

7. The method of claim 6, wherein calibrating the dynamic scene cameras comprises:
fitting a smooth function to changes in focal length provided by the dynamic scene cameras and using the smooth function as a regularization across frames to account for zoom changes and to reduce inconsistencies in calibration.

8. The method of claim 1, wherein:
capturing the multi-actor performances comprises capturing a color chart;
capturing the single-actor facial detail comprises capturing the color chart; and
the method further comprises:
calibrating the color of the captured multi-actor performances and of the captured single-actor facial detail to each other using the captured color chart.

9. The method of claim 1, wherein capturing the multi-actor performances comprises capturing multiple actors performing a variety of actions on the stage.

10. The method of claim 1, wherein capturing the single-actor facial detail comprises capturing a single actor performing a variety of facial expressions.

11. The method of claim 1, wherein:
rendering the LQ and HQ Gaussian splatting models to produce paired image sequences for each actor for which single-actor facial detail is captured comprises:
rendering LQ red-green-blue (RGB) images and LQ alpha images from the LQ Gaussian splatting model; and
rendering HQ RGB images and HQ alpha images from the HQ Gaussian splatting model; and
training the diffusion-based detail enhancement model using the paired image sequences comprises:
comparing a current output frame of the HQ RGB images to a previous output frame of the HQ RGB images to generate a warped version of the previous output frame and a warp validity mask; and
conditioning the diffusion-based detail enhancement model using the LQ RGB images, LQ alpha images, warped version of the previous output frame, and warp validity mask.

12. The method of claim 1, wherein rendering the HQ images for facial closeups by applying the trained diffusion-based detail enhancement model comprises outputting detail-enhanced red-green-blue (RGB) images and detail-enhanced alpha images for alpha compositing.

13. A method, comprising:
capturing, using a face rig including a plurality of face cameras, detailed images of an actor’s face performing various facial expressions;
capturing, using a scene rig including a plurality of scene cameras, full-body performances of the actor;
reconstructing, via four-dimensional Gaussian splatting, a time-varying volumetric representation of the actor based on the captured detailed images from the face rig and the captured full-body performances from the scene rig;
rendering, from the volumetric representation and along simulated camera trajectories, a plurality of two-dimensional video sequences of the actor to produce a multi-view training dataset paired with associated camera parameters;
fine-tuning a pretrained video generation model on the multi-view training dataset and the associated camera parameters to create a customized video generation model associated with the actor while preserving identity consistency across varying viewpoints; and
generating, by providing the customized video generation model with a token associated with the actor and a specified camera trajectory, an actor-specific video output that follows the specified camera trajectory and that maintains coherent multi-view identity of the actor.

14. The method of claim 13, further comprising applying a video relighting model to the rendered two-dimensional video sequences to generate relighted video sequences, wherein the multi-view training dataset further comprises the relighted video sequences.

15. The method of claim 13, wherein the multi-view training dataset is augmented by rendering the volumetric representation along a plurality of diverse camera trajectories generated by randomly sampling starting and ending positions within a specified radius and interpolating between the starting and ending positions to create smooth motion paths.

16. The method of claim 13, wherein generating the actor-specific video output further comprises providing a text prompt to the customized video generation model.

17. The method of claim 13, wherein the plurality of face cameras comprise face cameras respectively positioned to capture the actor’s face from a front of the face and from sides of the face.

18. The method of claim 13, further comprising pretraining a video generation model to obtain the pretrained video generation model, wherein the pretraining comprises training the video generation model to recognize three-dimensional camera positions and parameters as input.

19. The method of claim 18, wherein the video generation model comprises a video diffusion model.

20. A system, comprising:
at least one physical processor; and
physical memory comprising computer-executable instructions that, when executed by the physical processor, cause the physical processor to:
reconstruct, from captured multi-actor performances of multiple actors in a scene rig including a stage and multiple scene cameras, dynamic performances using four-dimensional Gaussian splatting;
construct, for each actor of the multiple actors and from captured single-actor facial detail in a face rig including multiple face cameras, a low-quality (LQ) Gaussian splatting model and a high-quality (HQ) Gaussian splatting model;
render the LQ and HQ Gaussian splatting models to produce paired image sequences for each actor;
train a diffusion-based detail enhancement model using the paired image sequences; and
render HQ images for facial closeups by applying the trained diffusion-based detail enhancement model to the reconstructed dynamic performances from the scene rig.
